(19) United States
(12) Patent Application Publication
(10) Pub. No.: US 2006/0036799 A1
(43) Pub. Date: Feb. 16, 2006

(54) Multi-platform development and execution of graphical programs

(75) Inventors: Darshan K. Shah, Austin, TX (US); Jeffrey L. Kodosky, Austin, TX (US)

Correspondence Address: MEYERTONS, HOOD, KIVLIN, KOWERT & GOETZEL, P.C., P.O. BOX 398, AUSTIN, TX, 78767-0398, US

(73) Assignee: National Instruments Corporation

(21) Appl. No.: 11/003,608

(22) Filed: Dec. 3, 2004

Related U.S. Application Data
(60) Provisional application No. 60/601,283, filed on Aug. 13, 2004.

(51) Int. Cl. G06F 12/14; G06F 9/44

(52) U.S. Cl. 711/100; 711/170; 717/109; 717/113

(57) ABSTRACT

System and method for developing/executing graphical programs for and on multiple platforms. A graphical program comprising a plurality of interconnected nodes which visually indicate functionality of the graphical program, and a plurality of host target manager programs (TMPs), each corresponding to a possible execution target of the graphical program, are stored. Two or more of the host TMPs are executed to programmatically generate respective instances of the graphical program corresponding to respective execution targets, each executable by a device TMP on the respective execution target. Each of the respective instances are displayed on a display device via the host TMPs, and edits to one instance may automatically be reflected in the other(s). Portions of the program unsuitable for execution on an execution target may be indicated, and may be removed, replaced, or modified e.g., automatically and/or manually. The respective instances may be deployed on the respective execution targets for execution.

### PRIORITY DATA

This invention claims benefit of priority to U.S. Provisional Application 60/601,283, titled “Multi-Platform Development and Execution of Graphical Programs”, filed on Aug. 13, 2004, whose inventors were Darshan Shah and Jeffrey L. Kodosky.

### FIELD OF THE INVENTION

The present invention relates to the field of graphical programming, and more particularly to a system and method for developing and executing graphical programs for and on multiple platforms.

### DESCRIPTION OF THE RELATED ART

Traditionally, high level text-based programming languages have been used by programmers in writing application programs. Many different high level text-based programming languages exist, including BASIC, C, C++, Java, FORTRAN, Pascal, COBOL, ADA, APL, etc. Programs written in these high level text-based languages are translated to the machine language level by translators known as compilers or interpreters. The high level text-based programming languages in this level, as well as the assembly language level, are referred to herein as text-based programming environments.

Increasingly, computers are required to be used and programmed by those who are not highly trained in computer programming techniques. When traditional text-based programming environments are used, the user's programming skills and ability to interact with the computer system often become a limiting factor in the achievement of optimal utilization of the computer system.

There are numerous subtle complexities which a user must master before he can efficiently program a computer system in a text-based environment. The task of programming a computer system to model or implement a process often is further complicated by the fact that a sequence of mathematical formulas, steps or other procedures customarily used to conceptually model a process often does not closely correspond to the traditional text-based programming techniques used to program a computer system to model such a process. In other words, the requirement that a user program in a text-based programming environment places a level of abstraction between the user's conceptualization of the solution and the implementation of a method that accomplishes this solution in a computer program. Thus, a user often must substantially master different skills in order to both conceptualize a problem or process and then to program a computer to implement a solution to the problem or process. Since a user often is not fully proficient in techniques for programming a computer system in a text-based environment to implement his solution, the efficiency with which the computer system can be utilized often is reduced.

To overcome the above shortcomings, various graphical programming environments now exist which allow a user to construct a graphical program or graphical diagram, also referred to as a block diagram. U.S. Pat. Nos. 4,901,221; 4,914,568; 5,291,587; 5,301,301; and 5,301,336; among others, to Kodosky et al disclose a graphical programming environment which enables a user to easily and intuitively create a graphical program. Graphical programming environments such as that disclosed in Kodosky et al can be considered a higher and more intuitive way in which to interact with a computer. A graphically based programming environment can be represented at a level above text-based high level programming languages such as C, Basic, Java, etc.

A user may assemble a graphical program by selecting various icons or nodes which represent desired functionality, and then connecting the nodes together to create the program. The nodes or icons may be connected by lines representing data flow between the nodes, control flow, or execution flow. Thus the block diagram may include a plurality of interconnected icons such that the diagram created graphically displays a procedure or method for accomplishing a certain result, such as manipulating one or more input variables and/or producing one or more output variables. In response to the user constructing a diagram or graphical program using the block diagram editor, data structures and/or program instructions may be automatically constructed which characterize an execution procedure that corresponds to the displayed procedure. The graphical program may be compiled or interpreted by a computer.

A graphical program may have a graphical user interface. For example, in creating a graphical program, a user may create a front panel or user interface panel. The front panel may include various graphical user interface elements or front panel objects, such as user interface controls and/or indicators, that represent or display the respective input and output that will be used by the graphical program, and may include other icons which represent devices being controlled.

Thus, graphical programming has become a powerful tool available to programmers. Graphical programming environments such as the National Instruments LabVIEW product have become very popular. Tools such as LabVIEW have greatly increased the productivity of programmers, and increasing numbers of programmers are using graphical programming environments to develop their software applications. In particular, graphical programming tools are being used for test and measurement, data acquisition, process control, man machine interface (MMI), supervisory control and data acquisition (SCADA) applications, modeling, simulation, image processing/machine vision applications, and motion control, among others.

In parallel with the development of the graphical programming model, different types of devices have been developed which include a processing element, such as a processor or programmable hardware element (e.g., a field programmable gate array (FPGA)) for executing programs for operation of the devices. Examples of such devices include embedded devices, e.g., with microprocessors and/or FPGAs, personal digital assistants (PDAs), digital signal processors (DSPs), personal computers, and so forth. Each of these types of devices may have different capabilities and functionalities, i.e., may support different operations and features, and so may differ in the particular programs they are operable to execute. For example, an embedded device may not include or support a display device, and so a program that includes display functionality may not be appropriate or suitable for deployment on the device. As another example, an FPGA device that does not include floating point capability may not be suitable for executing an analysis or numeric processing program. Additionally, each general type of device, e.g., a PDA, DSP, etc., may have a variety of different sub-types or models, each of which may also have different capabilities, e.g., different display functionality, processing power, I/O, and so forth.

Typically, different development environments have been required to target programs for different types of devices. For example, LabVIEW, LabVIEW RT, LabVIEW FPGA, LabVIEW PDA, LabVIEW DSP, and LabVIEW embedded are different development and execution environments for various device types, and are used independently for developing and targeting graphical programs at various platforms. Additionally, developers have generally been required to know the specifics of each targeted device and to customize programs intended for deployment on each targeted device.

### SUMMARY OF THE INVENTION

One embodiment of the present invention comprises a system and method for creating and deploying a graphical program to multiple devices. The methods described may be used in conjunction with any of a variety of computer systems or devices, including, for example, desktop computers, real time devices, e.g., embedded devices, and programmable hardware based devices, such as those that use field programmable gate arrays (FPGAs), among others.

First a graphical program may be stored, e.g., on a host computer system, where the graphical program includes a plurality of interconnected nodes which visually indicates the functionality of the program. In some embodiments, the method may also include creating the graphical program, e.g., on the computer system (or on a different computer system). The graphical program may be created or assembled by the user arranging on a display a plurality of nodes or icons and then interconnecting the nodes to create the graphical program. The nodes may be interconnected in one or more of a data flow, control flow, or execution flow format. The graphical program may thus comprise a plurality of interconnected nodes or icons which visually indicates the functionality of the program, as noted above. The graphical program may comprise a block diagram and may also include a user interface portion or front panel portion. Where the graphical program includes a user interface portion, the user may optionally assemble the user interface on the display. As one example, the user may use the LabVIEW graphical programming development environment to create the graphical program.

A plurality of target manager programs may be stored, e.g., on the computer system, where each of the target manager programs corresponds to a possible execution target of the graphical program. For example, in a LabVIEW based embodiment, the plurality of target manager programs may include LabVIEW, LabVIEW RT, LabVIEW FPGA, LabVIEW PDA, LabVIEW DSP, and/or LabVIEW embedded, each of which facilitates deployment of the graphical program to a respective target device or platform.

A target manager, which may reside on the host computer (referred to as a host target manager) or a device (referred to as a device target manager) is a software component or set of components that may be operable to manage editing, compilation, deployment, and/or execution of graphical programs on a corresponding target, i.e., a target device. In preferred embodiments, the target manager may be provided in, by, or as part of, a development/execution environment, such as LabVIEW, for example. A single development/execution environment process, e.g., a LabVIEW process, may have one or more target manager instances at a given time. Each target manger instance may include one or more component instances such as, but not limited to, a compiler, syntax checker, execution engine, control or user interface (UI) palettes and functions palettes, among others.

Two or more of the host target manager programs may be executed to programmatically generate a respective two or more instances of the graphical program corresponding to respective execution targets, where each instance is executable by a respective device target manager program on the respective execution target. The execution targets may be any of a variety of targets, including, but no limited to, one or more of: a standalone hardware device, an expansion card, e.g., on the computer system or another computer system, and a device emulator stored in the memory medium, e.g., of computer system (or another computer system), among others.

In one embodiment, the graphical program may be stored on a non-volatile memory, e.g., on a hard drive, EPROM, etc., and programmatically generating the two or more instances of the graphical program may include storing the two or more instances of the graphical program in a volatile memory. Thus, while the original graphical program may be stored on non-volatile memory, the instances of the graphical program may be created and stored in volatile memory, such as the RAM of the computer system.

In cases where the graphical program is executable as is on an execution target, generating an instance of the graphical program may simply involve making a copy of the graphical program. However, some of the execution targets may have different attributes or capabilities that may affect the executability of the program on those targets. For example, an embedded device target may not have display capabilities, and so display-related portions of the program may not be appropriate. Thus, in some embodiments, programmatically generating the respective two or more instances of the graphical program may include, for at least one of the two or more instances, programmatically replacing one or more generic portions of the graphical program with one or more portions specific to the execution target. In other words, the method may automatically “customize” one or more portions of the instance graphical program as needed to facilitate deployment and execution of the instance on the execution target. In one embodiment, the block diagram of the instance may not be changed, but rather, underlying data structures and/or program code may be modified or replaced in accordance with the capabilities or attributes of the execution target.

Each of the two or more instances may be displayed on a display device via the host target manager programs. For example, each of the two or more instances may be displayed in a respective window in the development environment, e.g., LabVIEW, where they may be analyzed and edited as desired.

In some embodiments, programmatically generating the two or more instances of the graphical program may include: for each of the two or more instances of the graphical program, programmatically validating the instance of the graphical program. For example, the instance may be analyzed to determine if the instance is properly executable on the specified execution target. In one embodiment, programmatically validating the instance of the graphical program may include programmatically analyzing the instance to determine if there are any invalid portions of the instance, where, for example, the invalid portions of the instance of the graphical program may comprise portions that are not executable on the respective execution target.

If there are any invalid portions of the instance of the graphical program, the invalid portions may be graphically indicated, e.g., on the display device. For example, in one embodiment, the instance of the graphical program may be displayed with broken wires indicating the invalid portion or portions. In other embodiments, the invalid portions may be indicated via modified icons, color-coding, shading, boundary lines, or via any other type of graphical indicator. In yet another embodiment, the invalid portions may be indicated via text, e.g., via labels displayed next to the respective portions, and so forth.

In one embodiment, programmatically validating the instance of the graphical program may include, if there are any invalid portions of the instance of the graphical program, then 1) graphically indicating the invalid portions on a display, and 2) displaying information indicating how the invalid portions can be modified or replaced to enable execution of the instance on the first execution target.

In one embodiment, programmatically validating the instance of the graphical program may include, if there are any invalid portions of the instance of the graphical program, programmatically modifying the instance of the graphical program to correct the invalid portions, e.g., programmatically removing any invalid portions. In another embodiment, programmatically validating the instance of the graphical program may include, if there are any invalid portions of the instance of the graphical program, modifying the instance of the graphical program to correct the invalid portions based on received user input. For example, the user may provide input indicating modifications to the instance of the graphical program, or software may programmatically modify the instance of the graphical program.

In some embodiments, each of the respective host target manager programs may include an editor component whereby the user may edit the instances. Thus, for at least one of the two or more instances, the method may include executing the editor component of the corresponding host target manager program to edit the instance of the graphical program. In preferred embodiments, any edits made to one of the instances may be automatically made to the other instances of the graphical program. In other words, others of the two or more instances may be updated to include modifications made in editing the at least one of the two or more instances. Said another way, the instances may be “locked” regarding editing, where changes made to one automatically propagate to the other(s). Thus, modifying the instance of the graphical program may include programmatically performing the modifying on others of the two or more instances of the graphical program.

Once edits have been made, the validation process described above may be performed, and any invalid portions of the instances indicated. Due to the possible different capabilities of the execution targets, correcting (e.g., via editing or programmatically) an invalid portion in an instance for one execution target may result in one or more new invalid portions in another instance, which may then be detected in the validation process, and indicated as described above.

Thus, the modifying and programmatically validating may be performed in an iterative manner until there are no invalid portions in the two or more instances, or it is determined that the block diagram of one instance is incompatible with another, i.e., that editing the block diagram of one instance necessarily “breaks” that of another, in which case, the user may simply make a copy of the graphical program and process it separately from the original graphical program. In other words, the new graphical program (copy) may be made independent of the original, and, not being an instance, may be processed and deployed independently.

The two or more instances may be deployed on the respective execution targets. For example, the instances may be deployed onto the execution targets in response to user input. In some embodiments, deployment of the graphical program to a target device may require that the program (actually, an instance of the graphical program) be compiled prior to or as part of the deployment. Thus, in some embodiments, at least one of the respective host or device target manager programs may include a compiler component, executable to compile graphical programs, including instances of the graphical program described above. The method may then include executing the compiler component of the at least one host or device target manager program to compile the corresponding instance of the graphical program. For example, in some embodiments, deployment of the graphical program onto an embedded device may require that the graphical program be compiled or converted to a text-based program, e.g., a C program, and the C program compiled to machine executable code prior to deployment. In other embodiments, the intermediate form, e.g., the C program, may not be required.

In embodiments where the target device includes a programmable hardware element, such as an FPGA, the graphical program may be compiled or converted to a hardware configuration program, operable to configure the programmable hardware element to perform the specified functionality of the graphical program.

In some embodiments, user input specifying the two or more execution targets may be received, and the deployment performed in response to the user input. For example, receiving the user input may include displaying an icon on the display which represents the graphical program, displaying two or more icons on the display which respectively represent the two or more execution targets, and receiving the user input graphically associating the icon which represents the graphical program with each of the two or more icons which respectively represent the two or more execution targets. The deploying may then be performed in response to the graphical association.

In some embodiments, each of the respective device target manager programs may include an execution component. The respective two or more host target manager programs may be executed to execute the execution components of the respective device target manager programs to respectively execute the two or more instances of the graphical program on the respective execution targets. In another embodiment, at least one of the respective device target manager programs may include an execution component that is operable to implement executing the corresponding instance of the graphical program on the respective execution target independent from the corresponding host target manager program.

Thus, in some embodiments, the host and/or device target manager programs may include various components for performing respective functions related to creating, editing, debugging, deploying, and executing graphical programs, including instances of graphical programs. In preferred embodiments, these components may be modular, such that some components may be omitted from a target manager program if the corresponding functionality is not needed or is not appropriate.

In various embodiments, at least one of the respective execution targets may include a processor and memory, where after deployment, the corresponding instance of the graphical program is executable by the processor from the memory. In some embodiments, at least one of the respective execution targets includes a programmable hardware element, where after deployment, the corresponding instance of the graphical program is executable by the programmable hardware element. In further embodiments, one or more of the execution targets may include a combination of processor(s)/memory and programmable hardware elements, e.g., FPGAs.

Each of the target manager instances may or may not be associated with a physical resource, e.g., a hardware device. When not associated with a physical resource the target manager may allow the user to edit and compile the user's VIs, but not to execute them. The user may associate the target manager instance with a physical resource or a simulator or emulator in order to execute the user's VIs.

### BRIEF DESCRIPTION OF THE DRAWINGS

A better understanding of the present invention can be obtained when the following detailed description of the preferred embodiment is considered in conjunction with the following drawings, in which:

FIG. 1A illustrates a computer system operable to execute a graphical program according to an embodiment of the present invention;

FIG. 1B illustrates a network system comprising two or more computer systems that may implement an embodiment of the present invention;

FIG. 2A illustrates an instrumentation control system according to one embodiment of the invention;

FIG. 2B illustrates an industrial automation system according to one embodiment of the invention;

FIG. 3A is a high level block diagram of an exemplary system which may execute or utilize graphical programs;

FIG. 3B illustrates an exemplary system which may perform control and/or simulation functions utilizing graphical programs;

FIG. 4 is an exemplary block diagram of the computer systems of FIGS. 1A, 1B, 2A and 2B and 3B;

FIG. 5 is a flowchart diagram illustrating one embodiment of a method for creating and deploying a graphical program to multiple devices;

FIG. 6 illustrates example target managers with exemplary components, according to one embodiment; and

FIG. 7 illustrates display of multiple instances of a single graphical program.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

### INCORPORATION BY REFERENCE

The following references are hereby incorporated by reference in their entirety as though fully and completely set forth herein:
U.S. Provisional Application 60/601,283, titled “Multi-Platform Development and Execution of Graphical Programs”, filed on Aug. 13, 2004.
U.S. application Ser. No. 10/177,553 titled “Target Device-Specific Syntax and Semantic Analysis For a Graphical Program,” filed on Jun. 21, 2002, currently pending.
U.S. Pat. No. 4,914,568 titled “Graphical System for Modeling a Process and Associated Method,” issued on Apr. 3, 1990.
U.S. Pat. No. 5,481,741 titled “Method and Apparatus for Providing Attribute Nodes in a Graphical Data Flow Environment”.
U.S. Pat. No. 6,173,438 titled “Embedded Graphical Programming System” filed Aug. 18, 1997.
U.S. Pat. No. 6,219,628 titled “System and Method for Configuring an Instrument to Perform Measurement Functions Utilizing Conversion of Graphical Programs into Hardware Implementations,” filed Aug. 18, 1997.
U.S. Patent Application Publication No. 20010020291 (Ser. No. 09/745,023) titled “System and Method for Programmatically Generating a Graphical Program in Response to Program Information,” filed Dec. 20, 2000, currently pending.
   Terms

The following is a glossary of terms used in the present application:

Memory Medium—Any of various types of memory devices or storage devices. The term “memory medium” is intended to include an installation medium, e.g., a CD-ROM, floppy disks 104, or tape device; a computer system memory or random access memory such as DRAM, DDR RAM, SRAM, EDO RAM, Rambus RAM, etc.; or a non-volatile memory such as a magnetic media, e.g., a hard drive, or optical storage. The memory medium may comprise other types of memory as well, or combinations thereof. In addition, the memory medium may be located in a first computer in which the programs are executed, or may be located in a second different computer which connects to the first computer over a network, such as the Internet. In the latter instance, the second computer may provide program instructions to the first computer for execution. The term “memory medium” may include two or more memory mediums which may reside in different locations, e.g., in different computers that are connected over a network.

Carrier Medium—a memory medium as described above, as well as signals such as electrical, electromagnetic, or digital signals, conveyed via a communication medium such as a bus, network and/or a wireless link.

Programmable Hardware Element—includes various types of programmable hardware, reconfigurable hardware, programmable logic, or field-programmable devices (FPDs), such as one or more FPGAs (Field Programmable Gate Arrays), or one or more PLDs (Programmable Logic Devices), such as one or more Simple PLDs (SPLDs) or one or more Complex PLDs (CPLDs), or other types of programmable hardware. A programmable hardware element may also be referred to as “reconfigurable logic”.

Medium—includes one or more of a memory medium, carrier medium, and/or programmable hardware element; encompasses various types of mediums that can either store program instructions/data structures or can be configured with a hardware configuration program. For example, a medium that is “configured to perform a function or implement a software object” may be 1) a memory medium or carrier medium that stores program instructions, such that the program instructions are executable by a processor to perform the function or implement the software object; 2) a medium carrying signals that are involved with performing the function or implementing the software object; and/or 3) a programmable hardware element configured with a hardware configuration program to perform the function or implement the software object.

Program—the term “program” is intended to have the full breadth of its ordinary meaning. The term “program” includes 1) a software program which may be stored in a memory and is executable by a processor or 2) a hardware configuration program useable for configuring a programmable hardware element.

Software Program—the term “software program” is intended to have the full breadth of its ordinary meaning, and includes any type of program instructions, code, script and/or data, or combinations thereof, that may be stored in a memory medium and executed by a processor. Exemplary software programs include programs written in text-based programming languages, such as C, C++, Pascal, Fortran, Cobol, Java, assembly language, etc.; graphical programs (programs written in graphical programming languages); assembly language programs; programs that have been compiled to machine language; scripts; and other types of executable software. A software program may comprise two or more software programs that interoperate in some manner.

Hardware Configuration Program—a program, e.g., a netlist or bit file, that can be used to program or configure a programmable hardware element.

Graphical Program—A program comprising a plurality of interconnected nodes or icons, wherein the plurality of interconnected nodes or icons visually indicate functionality of the program.

The following provides examples of various aspects of graphical programs. The following examples and discussion are not intended to limit the above definition of graphical program, but rather provide examples of what the term “graphical program” encompasses:

The nodes in a graphical program may be connected in one or more of a data flow, control flow, and/or execution flow format. The nodes may also be connected in a “signal flow” format, which is a subset of data flow.

Exemplary graphical program development environments which may be used to create graphical programs include LabVIEW, DasyLab, DiaDem and Matrixx/SystemBuild from National Instruments, Simulink from the MathWorks, VEE from Agilent, WiT from Coreco, Vision Program Manager from PPT Vision, SoftWIRE from Measurement Computing, Sanscript from Northwoods Software, Khoros from Khoral Research, SnapMaster from HEM Data, VisSim from Visual Solutions, ObjectBench by SES (Scientific and Engineering Software), and VisiDAQ from Advantech, among others.

The term “graphical program” includes models or block diagrams created in graphical modeling environments, wherein the model or block diagram comprises interconnected nodes or icons that visually indicate operation of the model or block diagram; exemplary graphical modeling environments include Simulink, SystemBuild, VisSim, Hypersignal Block Diagram, etc.

A graphical program may be represented in the memory of the computer system as data structures and/or program instructions. The graphical program, e.g., these data structures and/or program instructions, may be compiled or interpreted to produce machine language that accomplishes the desired method or process as shown in the graphical program.

Input data to a graphical program may be received from any of various sources, such as from a device, unit under test, a process being measured or controlled, another computer program, a database, or from a file. Also, a user may input data to a graphical program or virtual instrument using a graphical user interface, e.g., a front panel.

A graphical program may optionally have a GUI associated with the graphical program. In this case, the plurality of interconnected nodes are often referred to as the block diagram portion of the graphical program.

Node—In the context of a graphical program, an element that may be included in a graphical program. A node may have an associated icon that represents the node in the graphical program, as well as underlying code or data that implements functionality of the node. Exemplary nodes include function nodes, terminal nodes, structure nodes, etc. Nodes may be connected together in a graphical program by connection icons or wires.

Data Flow Graphical Program (or Data Flow Diagram)—A graphical program or diagram comprising a plurality of interconnected nodes, wherein the connections between the nodes indicate that data produced by one node is used by another node.

Graphical User Interface—this term is intended to have the full breadth of its ordinary meaning. The term “Graphical User Interface” is often abbreviated to “GUI”. A GUI may comprise only one or more input GUI elements, only one or more output GUI elements, or both input and output GUI elements.

The following provides examples of various aspects of GUIs. The following examples and discussion are not intended to limit the ordinary meaning of GUI, but rather provide examples of what the term “graphical user interface” encompasses:

A GUI may comprise a single window having one or more GUI Elements, or may comprise a plurality of individual GUI Elements (or individual windows each having one or more GUI Elements), wherein the individual GUI Elements or windows may optionally be tiled together.

A GUI may be associated with a graphical program. In this instance, various mechanisms may be used to connect GUI Elements in the GUI with nodes in the graphical program. For example, when Input Controls and Output Indicators are created in the GUI, corresponding nodes (e.g., terminals) may be automatically created in the graphical program or block diagram. Alternatively, the user can place terminal nodes in the block diagram which may cause the display of corresponding GUI Elements front panel objects in the GUI, either at edit time or later at run time. As another example, the GUI may comprise GUI Elements embedded in the block diagram portion of the graphical program.

Front Panel—A Graphical User Interface that includes input controls and output indicators, and which enables a user to interactively control or manipulate the input being provided to a program, and view output of the program, while the program is executing.

A front panel is a type of GUI. A front panel may be associated with a graphical program as described above.

In an instrumentation application, the front panel can be analogized to the front panel of an instrument. In an industrial automation application the front panel can be analogized to the MMI (Man Machine Interface) of a device. The user may adjust the controls on the front panel to affect the input and view the output on the respective indicators.

Graphical User Interface Element—an element of a graphical user interface, such as for providing input or displaying output. Exemplary graphical user interface elements comprise input controls and output indicators

Input Control—a graphical user interface element for providing user input to a program. Exemplary input controls comprise dials, knobs, sliders, input text boxes, etc.

Output Indicator—a graphical user interface element for displaying output from a program. Exemplary output indicators include charts, graphs, gauges, output text boxes, numeric displays, etc. An output indicator is sometimes referred to as an “output control”.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

Measurement Device—includes instruments, data acquisition devices, smart sensors, and any of various types of devices that are operable to acquire and/or store data. A measurement device may also optionally be further operable to analyze or process the acquired or stored data. Examples of a measurement device include an instrument, such as a traditional stand-alone “box” instrument, a computer-based instrument (instrument on a card) or external instrument, a data acquisition card, a device external to a computer that operates similarly to a data acquisition card, a smart sensor, one or more DAQ or measurement cards or modules in a chassis, an image acquisition device, such as an image acquisition (or machine vision) card (also called a video capture board) or smart camera, a motion control device, a robot having machine vision, and other similar types of devices. Exemplary “stand-alone” instruments include oscilloscopes, multimeters, signal analyzers, arbitrary waveform generators, spectroscopes, and similar measurement, test, or automation instruments.

A measurement device may be further operable to perform control functions, e.g., in response to analysis of the acquired or stored data. For example, the measurement device may send a control signal to an external system, such as a motion control system or to a sensor, in response to particular data. A measurement device may also be operable to perform automation functions, i.e., may receive and analyze data, and issue automation control signals in response.

Target—includes any device, either hardware or virtual, e.g., an emulator, to which a program may be deployed for execution.

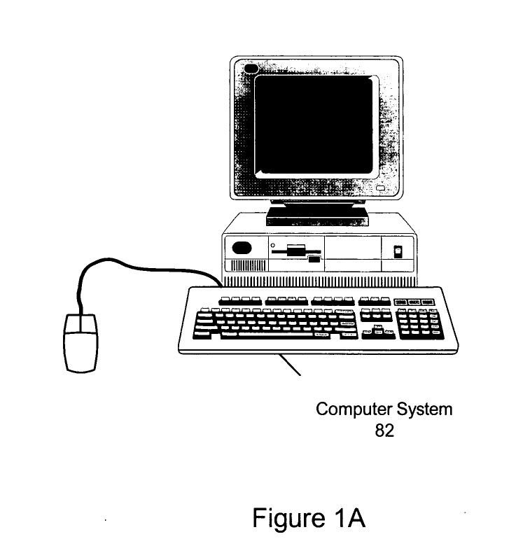

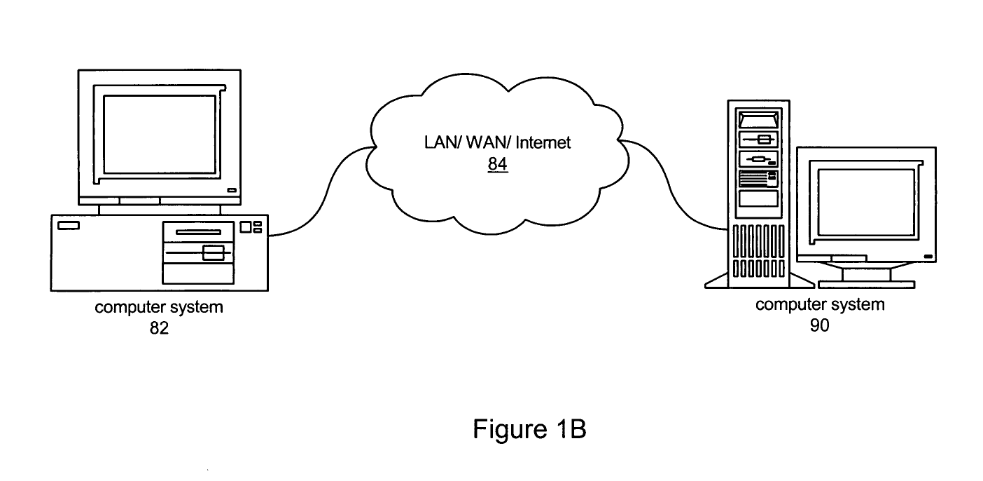

FIG. 1A—Computer System

FIG. 1A illustrates a computer system 82 suitable for implementing embodiments of the methods described below. One embodiment of a method for creating a graphical program and deploying the graphical program to various target platforms is described below.

As shown in FIG. 1A, the computer system 82 may include a display device operable to display the graphical program as the graphical program is created and/or executed. The display device may also be operable to display a graphical user interface or front panel of the graphical program during execution of the graphical program. The graphical user interface may comprise any type of graphical user interface, e.g., depending on the computing platform.

The computer system 82 may include a memory medium(s) on which one or more computer programs or software components according to one embodiment of the present invention may be stored. For example, the memory medium may store one or more programs, e.g., graphical programs, which are executable to perform the methods described herein. Also, the memory medium may store a graphical programming development environment application used to create and/or execute such graphical programs. The memory medium may also store operating system software, as well as other software for operation of the computer system. Various embodiments further include receiving or storing instructions and/or data implemented in accordance with the foregoing description upon a carrier medium.

FIG. 1B—Computer Network

FIG. 1B illustrates a system including a first computer system 82 that is coupled to a second computer system 90. The computer system 82 may be connected through a network 84 (or a computer bus) to the second computer system 90. The computer systems 82 and 90 may each be any of various types, as desired. The network 84 can also be any of various types, including a LAN (local area network), WAN (wide area network), the Internet, or an Intranet, among others. The computer systems 82 and 90 may execute a graphical program in a distributed fashion. For example, computer 82 may execute a first portion of the block diagram of a graphical program and computer system 90 may execute a second portion of the block diagram of the graphical program. As another example, computer 82 may display the graphical user interface of a graphical program and computer system 90 may execute the block diagram of the graphical program.

In one embodiment, the graphical user interface of the graphical program may be displayed on a display device of the computer system 82, and the block diagram may execute on a device 190 connected to the computer system 82. The device 190 may include a programmable hardware element and/or may include a processor and memory medium which may execute a real time operating system. In one embodiment, the graphical program may be downloaded and executed on the device 190. For example, an application development environment with which the graphical program is associated may provide support for downloading a graphical program for execution on the device in a real time system.

Exemplary Systems

Embodiments of the present invention may be involved with performing test and/or measurement functions; controlling and/or modeling instrumentation or industrial automation hardware; modeling and simulation functions, e.g., modeling or simulating a device or product being developed or tested, etc. Exemplary test applications where the graphical program may be used include hardware-in-the-loop testing and rapid control prototyping, among others.

However, it is noted that the present invention can be used for a plethora of applications and is not limited to the above applications. In other words, applications discussed in the present description are exemplary only, and the present invention may be used in any of various types of systems. Thus, the system and method of the present invention is operable to be used in any of various types of applications, including the control of other types of devices such as multimedia devices, video devices, audio devices, telephony devices, Internet devices, etc., as well as general purpose software applications such as word processing, spreadsheets, network control, network monitoring, financial applications, games, etc.

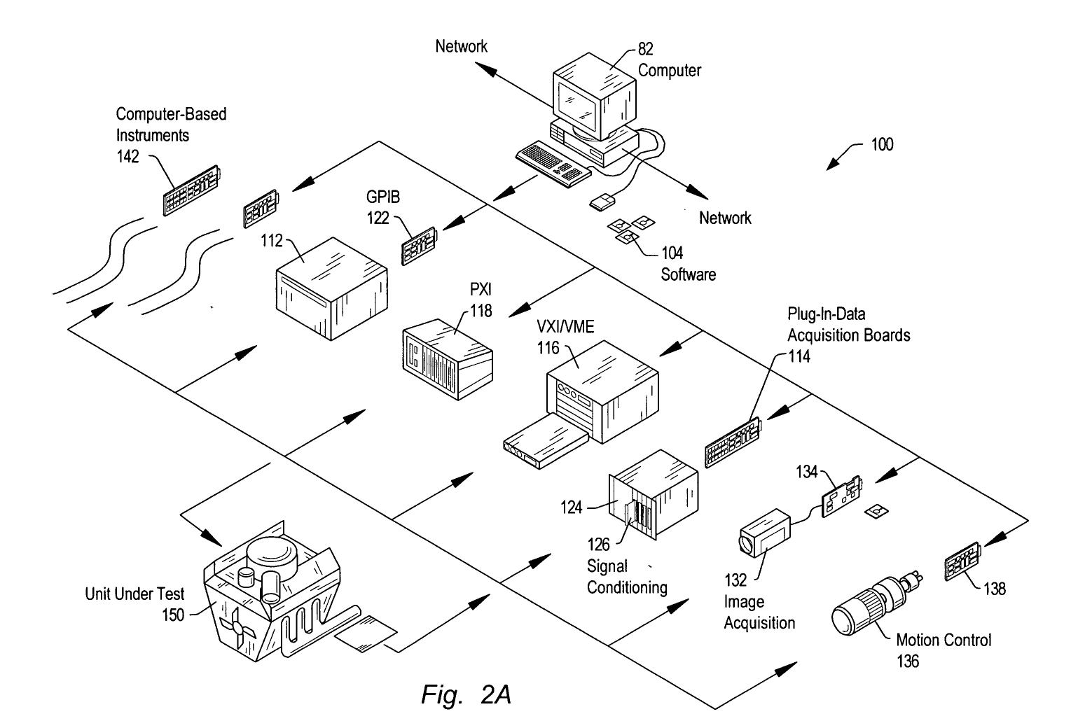

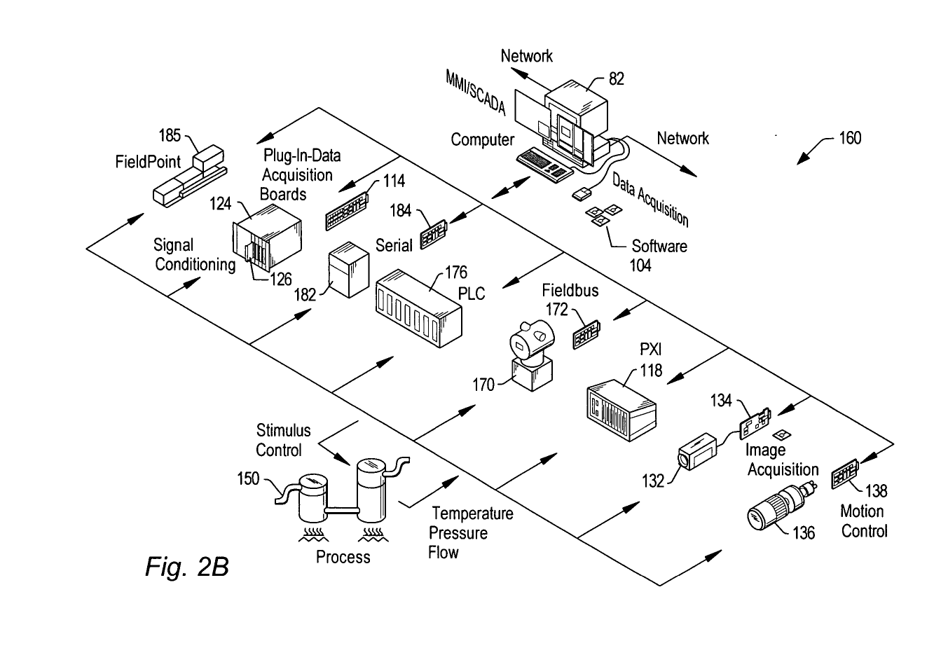

FIG. 2A illustrates an exemplary instrumentation control system 100 which may implement embodiments of the invention. The system 100 comprises a host computer 82 which connects to one or more instruments. The host computer 82 may comprise a CPU, a display screen, memory, and one or more input devices such as a mouse or keyboard as shown. The computer 82 may operate with the one or more instruments to analyze, measure or control a unit under test (UUT) or process 150.

The one or more instruments may include a GPIB instrument 112 and associated GPIB interface card 122, a data acquisition board 114 and associated signal conditioning circuitry 124, a VXI instrument 116, a PXI instrument 118, a video device or camera 132 and associated image acquisition (or machine vision) card 134, a motion control device 136 and associated motion control interface card 138, and/or one or more computer based instrument cards 142, among other types of devices. The computer system may couple to and operate with one or more of these instruments. The instruments may be coupled to a unit under test (UUT) or process 150, or may be coupled to receive field signals, typically generated by transducers. The system 100 may be used in a data acquisition and control application, in a test and measurement application, an image processing or machine vision application, a process control application, a man-machine interface application, a simulation application, or a hardware-in-the-loop validation application, among others.

FIG. 2B illustrates an exemplary industrial automation system 160 which may implement embodiments of the invention. The industrial automation system 160 is similar to the instrumentation or test and measurement system 100 shown in FIG. 2A. Elements which are similar or identical to elements in FIG. 2A have the same reference numerals for convenience. The system 160 may comprise a computer 82 which connects to one or more devices or instruments. The computer 82 may comprise a CPU, a display screen, memory, and one or more input devices such as a mouse or keyboard as shown. The computer 82 may operate with the one or more devices to a process or device 150 to perform an automation function, such as MMI (Man Machine Interface), SCADA (Supervisory Control and Data Acquisition), portable or distributed data acquisition, process control, advanced analysis, or other control, among others.

The one or more devices may include a data acquisition board 114 and associated signal conditioning circuitry 124, a PXI instrument 118, a video device 132 and associated image acquisition card 134, a motion control device 136 and associated motion control interface card 138, a fieldbus device 170 and associated fieldbus interface card 172, a PLC (Programmable Logic Controller) 176, a serial instrument 182 and associated serial interface card 184, or a distributed data acquisition system, such as the Fieldpoint system available from National Instruments, among other types of devices.

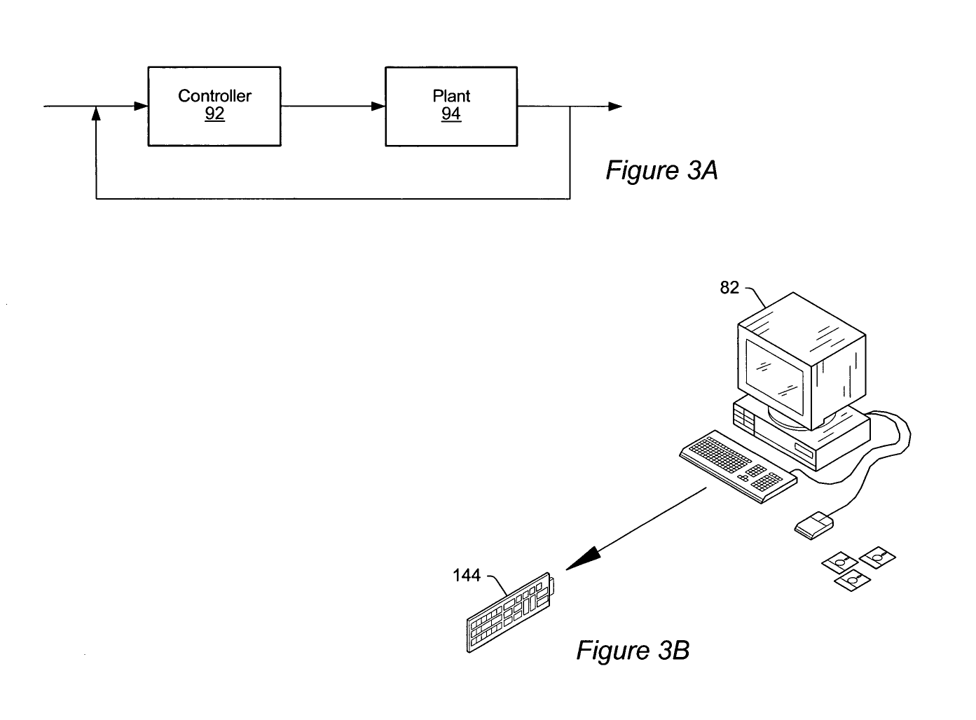

FIG. 3A is a high level block diagram of an exemplary system which may execute or utilize graphical programs. FIG. 3A illustrates a general high-level block diagram of a generic control and/or simulation system which comprises a controller 92 and a plant 94. The controller 92 represents a control system/algorithm the user may be trying to develop. The plant 94 represents the system the user may be trying to control. For example, if the user is designing an ECU for a car, the controller 92 is the ECU and the plant 94 is the car's engine (and possibly other components such as transmission, brakes, and so on.) As shown, a user may create a graphical program that specifies or implements the functionality of one or both of the controller 92 and the plant 94. For example, a control engineer may use a modeling and simulation tool to create a model (graphical program) of the plant 94 and/or to create the algorithm (graphical program) for the controller 92.

FIG. 3B illustrates an exemplary system which may perform control and/or simulation functions. As shown, the controller 92 may be implemented by a computer system 82 or other device (e.g., including a processor and memory medium and/or including a programmable hardware element) that executes or implements a graphical program. In a similar manner, the plant 94 may be implemented by a computer system or other device 144 (e.g., including a processor and memory medium and/or including a programmable hardware element) that executes or implements a graphical program, or may be implemented in or as a real physical system, e.g., a car engine.

In one embodiment of the invention, one or more graphical programs may be created which are used in performing rapid control prototyping. Rapid Control Prototyping (RCP) generally refers to the process by which a user develops a control algorithm and quickly executes that algorithm on a target controller connected to a real system. The user may develop the control algorithm using a graphical program, and the graphical program may execute on the controller 92, e.g., on a computer system or other device. The computer system 82 may be a platform that supports real time execution, e.g., a device including a processor that executes a real time operating system (RTOS), or a device including a programmable hardware element.

In one embodiment of the invention, one or more graphical programs may be created which are used in performing Hardware in the Loop (HIL) simulation. Hardware in the Loop (HIL) refers to the execution of the plant model 94 in real time to test operation of a real controller 92. For example, once the controller 92 has been designed, it may be expensive and complicated to actually test the controller 92 thoroughly in a real plant, e.g., a real car. Thus, the plant model (implemented by a graphical program) is executed in real time to make the real controller 92 “believe” or operate as if it is connected to a real plant, e.g., a real engine.

In the embodiments of FIGS. 2A, 2B, and 3B above, one or more of the various devices may couple to each other over a network, such as the Internet. In one embodiment, the user operates to select a target device from a plurality of possible target devices for programming or configuration using a graphical program. Thus the user may create a graphical program on a computer and use (execute) the graphical program on that computer or deploy the graphical program to a target device (for remote execution on the target device) that is remotely located from the computer and coupled to the computer through a network.

Graphical software programs which perform data acquisition, analysis and/or presentation, e.g., for measurement, instrumentation control, industrial automation, modeling, or simulation, such as in the applications shown in FIGS. 2A and 2B, may be referred to as virtual instruments.

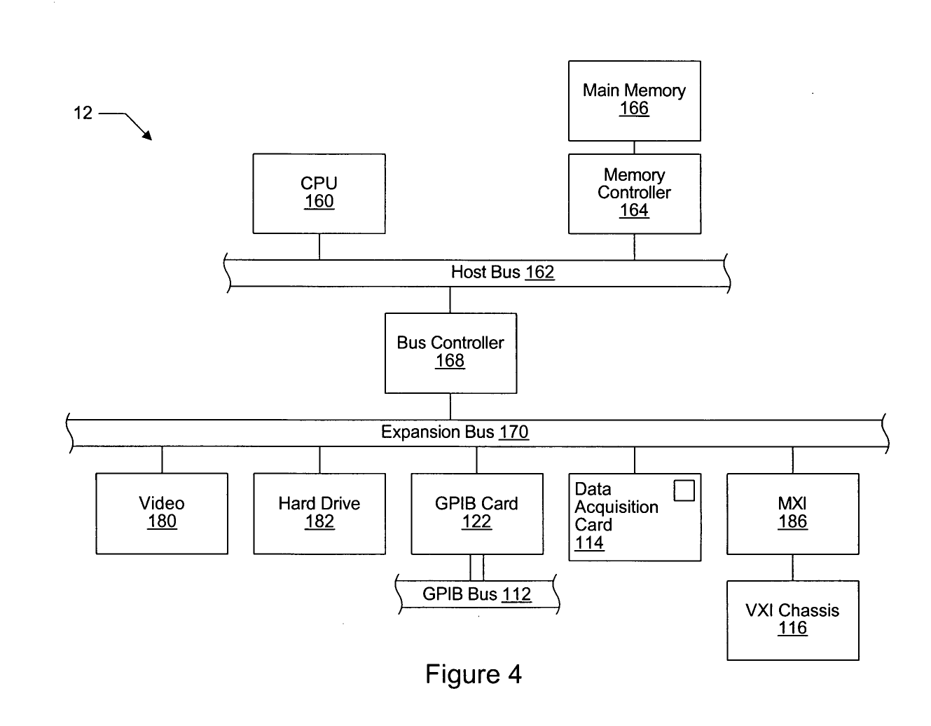

FIG. 4—Computer System Block Diagram

FIG. 4 is a block diagram representing one embodiment of the computer system 82 and/or 90 illustrated in FIGS. 1A and 1B, or computer system 82 shown in FIG. 2A or 2B. It is noted that any type of computer system configuration or architecture can be used as desired, and FIG. 4 illustrates a representative PC embodiment. It is also noted that the computer system may be a general purpose computer system, a computer implemented on a card installed in a chassis, or other types of embodiments. Elements of a computer not necessary to understand the present description have been omitted for simplicity.

The computer may include at least one central processing unit or CPU (processor) 160 which is coupled to a processor or host bus 162. The CPU 160 may be any of various types, including an x86 processor, e.g., a Pentium class, a PowerPC processor, a CPU from the SPARC family of RISC processors, as well as others. A memory medium, typically comprising RAM and referred to as main memory, 166 is coupled to the host bus 162 by means of memory controller 164. The main memory 166 may store graphical programs and a graphical programming environment in accordance with embodiments of the present invention. The main memory may also store operating system software, as well as other software for operation of the computer system.

The host bus 162 may be coupled to an expansion or input/output bus 170 by means of a bus controller 168 or bus bridge logic. The expansion bus 170 may be the PCI (Peripheral Component Interconnect) expansion bus, although other bus types can be used. The expansion bus 170 includes slots for various devices such as described above. The computer 82 further comprises a video display subsystem 180 and hard drive 182 coupled to the expansion bus 170.

As shown, a device 190 may also be connected to the computer. The device 190 may include a processor and memory which may execute a real time operating system. The device 190 may also or instead comprise a programmable hardware element. The computer system may be operable to deploy a graphical program to the device 190 for execution of the graphical program on the device 190. The deployed graphical program may take the form of graphical program instructions or data structures that directly represents the graphical program. Alternatively, the deployed graphical program may take the form of text code (e.g., C code) generated from the graphical program. As another example, the deployed graphical program may take the form of compiled code generated from either the graphical program or from text code that in turn was generated from the graphical program.

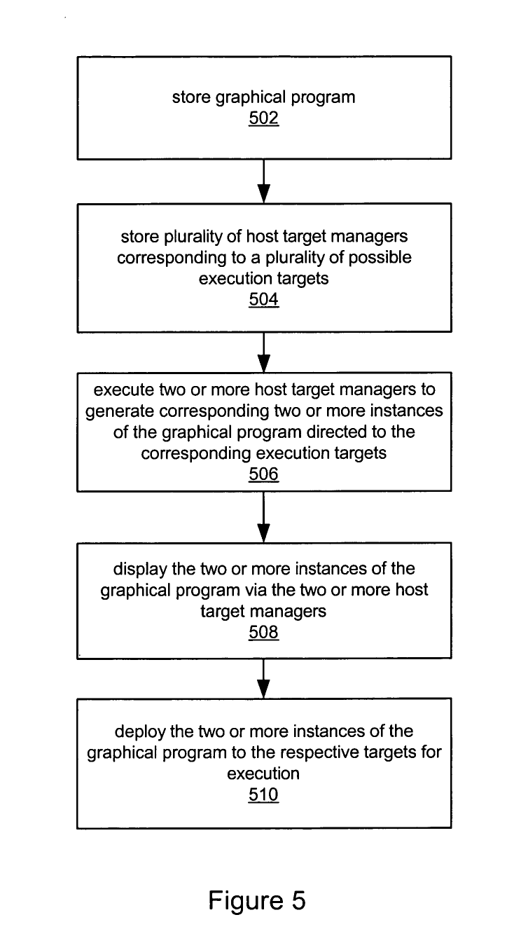

FIG. 5—Creating And Deploying A Graphical Program To Multiple Devices

FIG. 5 illustrates a method for creating and deploying a graphical program to multiple devices. The method shown in FIG. 5 may be used in conjunction with any of the computer systems or devices shown in the above Figures, among other devices. In various embodiments, some of the steps shown may be performed concurrently, in a different order than shown, or may be omitted. Additional steps may also be performed as desired. As shown, this method may operate as follows.

First, in 502, a graphical program may be stored, e.g., on the computer system 82, where the graphical program includes a plurality of interconnected nodes which visually indicates the functionality of the program.

In some embodiments, the method may also include creating the graphical program, e.g., on the computer system 82 (or on a different computer system). The graphical program may be created or assembled by the user arranging on a display a plurality of nodes or icons and then interconnecting the nodes to create the graphical program. In response to the user assembling the graphical program, data structures may be created and stored which represent the graphical program. The nodes may be interconnected in one or more of a data flow, control flow, or execution flow format. The graphical program may thus comprise a plurality of interconnected nodes or icons which visually indicates the functionality of the program, as noted above. As also noted above, the graphical program may comprise a block diagram and may also include a user interface portion or front panel portion. Where the graphical program includes a user interface portion, the user may optionally assemble the user interface on the display. As one example, the user may use the LabVIEW graphical programming development environment to create the graphical program.

In an alternate embodiment, the graphical program may be created in 262 by the user creating or specifying information, such as a prototype, followed by automatic or programmatic creation of the graphical program from the information. This functionality is described in U.S. patent application Ser. No. 09/587,682 titled “System and Method for Automatically Generating a Graphical Program to Perform an Image Processing Algorithm”, which is hereby incorporated by reference in its entirety as though fully and completely set forth herein. The graphical program may be created in other manners, either by the user or programmatically, as desired. The graphical program may implement a measurement function that is desired to be performed by the instrument.

In 504 a plurality of host target manager programs may be stored, e.g., on the computer system 82, where each of the target manager programs corresponds to a possible execution target of the graphical program. For example, in a LabVIEW based embodiment, the plurality of target manager programs may include LabVIEW, LabVIEW RT, LabVIEW FPGA, LabVIEW PDA, LabVIEW DSP, and/or LabVIEW embedded, each of which facilitates deployment of the graphical program to a respective target device or platform.

LabVIEW RT (real time) refers to a version of the LabVIEW software for creating a LabVIEW graphical program designed to execute on a, typically embedded, “real time” target executing a real time operating system (RTOS). LabVIEW FPGA refers to a version of the LabVIEW software for creating a LabVIEW graphical program designed to be deployed on a programmable hardware element. LabVIEW PDA refers to a version of the LabVIEW software for creating a LabVIEW graphical program designed to be deployed on a PDA. LabVIEW DSP refers to a version of the LabVIEW software for creating a LabVIEW graphical program designed to be deployed on a system including a digital signal processor (DSP). LabVIEW embedded refers to a version of the LabVIEW software for creating a LabVIEW graphical program designed to be deployed on an embedded target.

A target manager, which may reside on the host computer (referred to as a host target manager) or a device (referred to as a device target manager) is a software component or set of components that may be operable to manage editing, compilation, deployment, and/or execution of graphical programs on a corresponding target, i.e., a target device. In preferred embodiments, the target manager may be provided in, by, or as part of, a development/execution environment, such as LabVIEW, for example. A single development/execution environment process, e.g., a LabVIEW process, may have one or more target manager instances at a given time. Each target manger instance may include one or more sub-component instances such as, but not limited to, a compiler, syntax checker, execution engine, control or user interface (UI) palettes and functions palettes, among others.

In 506, two or more of the host target manager programs may be executed to programmatically generate a respective two or more instances of the graphical program corresponding to respective execution targets, where each instance is executable by a respective device target manager program on the respective execution target. The execution targets may be any of a variety of targets, including, but no limited to, one or more of: a standalone hardware device, an expansion card, e.g., on the computer system 82 or another computer system, and a device emulator stored in the memory medium, e.g., of computer system 82 (or another computer system).

In one embodiment, the graphical program may be stored on a non-volatile memory, e.g., on a hard drive, EPROM, etc., and programmatically generating the two or more instances of the graphical program may include storing the two or more instances of the graphical program in a volatile memory. Thus, while the original graphical program may be stored on non-volatile memory, the instances of the graphical program may be stored in volatile memory, such as the RAM of the computer system 82.

In cases where the graphical program is executable as is on an execution target, generating an instance of the graphical program may simply involve making a copy of the graphical program. However, some of the execution targets may have different attributes or capabilities that may affect the executability of the program on those targets. For example, an embedded device target may not have display capabilities, and so display-related portions of the program may not be appropriate. Thus, in some embodiments, programmatically generating the respective two or more instances of the graphical program may include, for at least one of the two or more instances, programmatically replacing one or more generic portions of the graphical program with one or more portions specific to the execution target. In other words, the method may “customize” one or more portions of the instance graphical program as needed to facilitate deployment and execution of the instance on the execution target. In one embodiment, the block diagram of the instance may not be changed, but rather, underlying data structures and/or program code may be modified or replaced in accordance with the capabilities or attributes of the execution target.

In 508, each of the two or more instances may be displayed on a display device via the host target manager programs. For example, each of the two or more instances may be displayed in a respective window in the development environment, e.g., LabVIEW where they may be analyzed and edited as desired.

In some embodiments, programmatically generating the two or more instances of the graphical program (in 506 above) may include: for each of the two or more instances of the graphical program, programmatically validating the instance of the graphical program. For example, the instance may be analyzed to determine if the instance is properly executable on the specified execution target. In one embodiment, programmatically validating the instance of the graphical program may include programmatically analyzing the instance to determine if there are any invalid portions of the instance, where, for example, the invalid portions of the instance of the graphical program may include portions that are not executable on the respective execution target.

If there are any invalid portions of the instance of the graphical program, the invalid portions may be graphically indicated, e.g., on the display device of 508. For example, in one embodiment, the instance of the graphical program may be displayed with broken wires indicating the invalid portion or portions. In other embodiments, the invalid portions may be indicated via modified icons, color-coding, shading, boundary lines, or via any other type of graphical indicator. In yet another embodiment, the invalid portions may be indicated via text, e.g., via labels displayed next to the respective portions, and so forth.

In one embodiment, programmatically validating the instance of the graphical program may include, if there are any invalid portions of the instance of the graphical program, then 1) graphically indicating the invalid portions on a display, and 2) displaying information indicating how the invalid portions can be modified or replaced to enable execution of the instance on the first execution target.

In one embodiment, programmatically validating the instance of the graphical program may include: if there are any invalid portions of the instance of the graphical program, programmatically modifying the instance of the graphical program to correct the invalid portions, e.g., programmatically removing any invalid portions and/or programmatically correcting or replacing the invalid portions. Thus, programmatically validating the instance of the graphical program may include: if there are any invalid portions of the instance of the graphical program, modifying the instance of the graphical program to correct the invalid portions based on received user input. For example, the user may provide input indicating modifications to the instance of the graphical program, or software may programmatically modify the instance.

In some embodiments, each of the respective host target manager programs may include an editor component whereby the user may edit the instances. Thus, for at least one of the two or more instances, the method may include executing the editor component of the corresponding host target manager program to edit the instance of the graphical program. In preferred embodiments, any edits made to one of the instances may be automatically made to the other instances of the graphical program. In other words, others of the two or more instances may be updated to include modifications made in editing the at least one of the two or more instances. Said another way, the two or more instances may be “locked” regarding editing, where changes made to one automatically propagate to the other(s). Thus, modifying the instance of the graphical program may include programmatically performing the modifying on others of the two or more instances of the graphical program.

Once edits have been made, the validation process described above in 506 may be performed, and any invalid portions of the instances indicated. Due to the possible different capabilities of the execution targets, correcting (e.g., via editing or programmatically) an invalid portion in an instance for one execution target may result in one or more new invalid portions in another instance, which may then be detected in the validation process, and indicated as described above.

Thus, the modifying and programmatically validating may be performed in an iterative manner until there are no invalid portions in the two or more instances, or it is determined that the block diagram of one instance is incompatible with another, i.e., that editing the block diagram of one instance necessarily “breaks” that of another, in which case, the user may simply make a copy of the graphical program and process it separately from the original graphical program. In other words, the new graphical program (copy) may be made independent of the original, and, not being an instance, may be processed and deployed independently.

In 510, the two or more instances may be deployed on the respective execution targets. For example, the instances may be deployed onto the execution targets in response to user input.

In some embodiments, deployment of the graphical program to a target device may require that the program (actually, an instance of the graphical program) be compiled prior to or as part of the deployment. Thus, in some embodiments, at least one of the respective host and/or device target manager programs may include a compiler component, executable to compile graphical programs, including instances of the graphical program described above. The method may then include executing the compiler component of the at least one host and/or device target manager program to compile the corresponding instance of the graphical program. For example, in some embodiments, deployment of the graphical program onto an embedded device may require that the graphical program be compiled or converted to a text-based program, e.g., a C program, and the C program compiled to machine executable code prior to deployment. In other embodiments, the intermediate form, e.g., the C program, may not be required.

In embodiments where the target device includes a programmable hardware element, such as an FPGA, the graphical program may be compiled or converted to a hardware configuration program, operable to configure the programmable hardware element to perform the specified functionality of the graphical program.

In some embodiments, user input specifying the two or more execution targets may be received, and deploying the two or more instances on the respective execution targets may be performed in response to the user input. For example, receiving the user input may include displaying an icon on the display which represents the graphical program, displaying two or more icons on the display which respectively represent the two or more execution targets, and receiving the user input graphically associating the icon which represents the graphical program with each of the two or more icons which respectively represent the two or more execution targets. The deploying may then be performed in response to the graphical association.

In some embodiments, each of the respective device target manager programs may include an execution component. The respective two or more host target manager programs may be executed to execute the execution components of the respective device target manager programs to respectively execute the two or more instances of the graphical program on the respective execution targets.

In another embodiment, at least one of the respective device target manager programs may include an execution component that is operable to implement executing the corresponding instance of the graphical program on the respective execution target independent from the corresponding host target manager program.

In some embodiments, at least one of the device target manager programs comprises a compiler component, and so the method may include executing the compiler component of the at least one device target manager program to compile the corresponding instance of the graphical program.

Thus, in some embodiments, the host and/or device target manager programs may include various components for performing respective functions related to creating, editing, debugging, deploying, and executing graphical programs, including instances of graphical programs. In preferred embodiments, these components may be modular, such that some components may be omitted from a target manager program if the corresponding functionality is not needed or is not appropriate. Further description of embodiments of target managers is provided below.

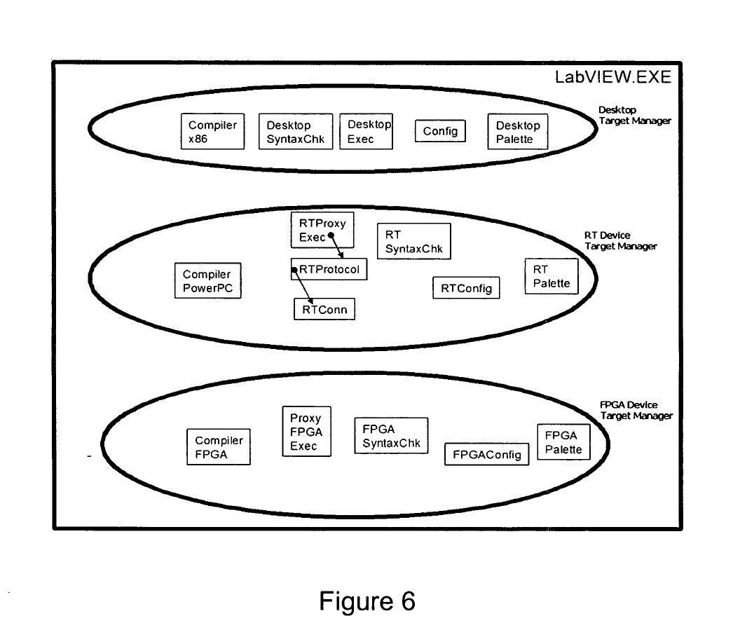

FIG. 6—Example Target Managers

FIG. 6 illustrates an example set of target managers (or target manager instances) under the LabVIEW development/execution environment. As FIG. 6 shows, in this example, target managers are provided for desktop targets, real time (RT) device targets, and programmable hardware device targets, more specifically, field programmable gate array (FPGA) device targets, although it should be noted that target managers may also be provide for any other type of target, including, for example, emulation software executing on the host computer. Each of the target managers shown includes various components, or, in the case that the target managers are themselves considered components, sub-components, directed to that particular target, such as a compiler component (or sub-component), a syntax checker component, an editing component, an execution engine, and/or a configuration component, among others. Note that any other components (or sub-components) may be included as desired.

Thus, the target manager may be responsible for managing the editing, compilation, and execution of VIs (graphical programs). Each target manager may be associated with a specific target resource matching the specific type of the target. Thus, a target manager instance may be created to support a specific type of a target, for example, an Intel x86 based processor running a Microsoft Windows operating system.

Following the above example, and referring to the top target manager of FIG. 6, a user may have desktop machine (e.g., a desktop person computer or workstation) that is Intel x86 based running Windows XP. A target manager instance may be created to manage the editing and running of VIs on the desktop machine. If the user creates a VI, the editing and running behavior of the VI may be managed by the target manager instance for the desktop machine. For example, when the user views a functions palette the palette component of the target manager may visually inform the user of the valid functions for the specific target type. The palettes may hide invalid functions or may highlight or otherwise indicate invalid functions graphically, such as, but not limited to, graying out, labeling, or otherwise modifying the appearance of the function icons. When the user edits a VI, the syntactical validity of the VI may be verified by a syntax checker component of the target manager. When the user runs a VI a compiler component and an execution component of the target manager instance may compile and execute the VI, respectively.

Referring now to the middle and bottom target managers of FIG. 6, in this example, a user may also have a remote PXI RT controller target and an FPGA target. A target manager instance may be created to manage the editing and running of VIs for each target. The components of each target manager instance may define the unique behavior for editing VIs for the specific target. For example, the FPGA target may not support floating point operations. The palette component of the target manager instance for the FPGA target may disable or hide functions requiring floating point operations. If the user loads a VI with floating point operations the FPGA syntax checker may indicate the VI is broken and should be edited or otherwise modified in order to compile and run successfully on the FPGA target. The target manager may also contain a component that manages the communication between the host computer and the remote target, e.g., a communication component. This communication sub-system may use an appropriate communication infrastructure, for example, Ethernet, Serial, PCI bus access, shared memory, etc., based on the type of remote target the host is connected to.

In various embodiments, at least one of the respective execution targets may include a processor and memory, where after deployment, the corresponding instance of the graphical program is executable by the processor from the memory. In some embodiments, at least one of the respective execution targets includes a programmable hardware element, where after deployment, the corresponding instance of the graphical program is executable by the programmable hardware element, e.g., after conversion to a hardware configuration program. In further embodiments, one or more of the execution targets may include a combination of processor(s)/memory and programmable hardware elements, e.g., FPGAs. In these embodiments, various portions of the graphical program may be compiled or converted to appropriate forms for execution on the target device(s).

Each of the target manager instances may or may not be associated with a physical resource, e.g., a hardware device. When not associated with a physical resource the target manager may allow the user to edit and compile the user's VIs, but not to execute them. The user may then associate the target manager instance with a physical resource or a simulator or emulator in order to execute the user's VIs.

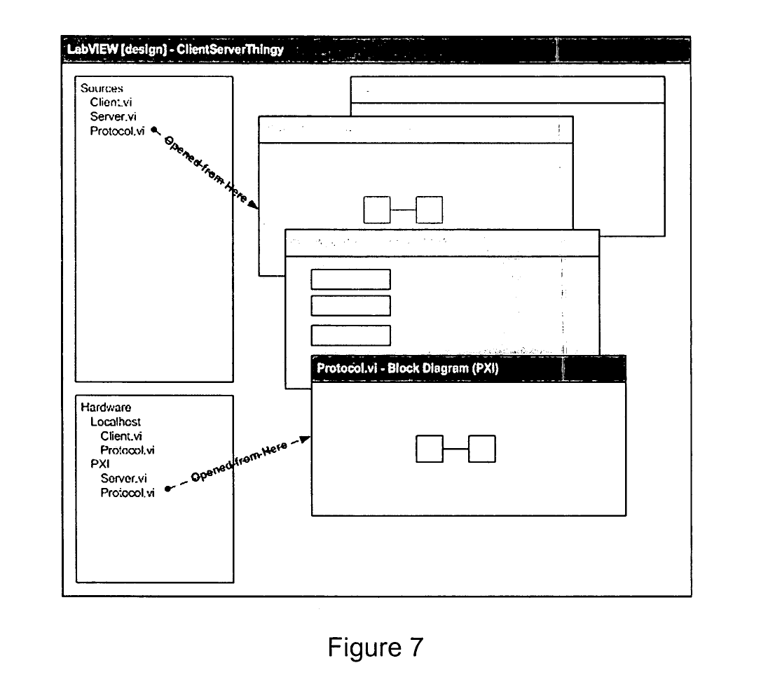

FIG. 7—Multiple Instances of a Single Graphical Program

As noted above, users may edit the same VI on multiple targets simultaneously. A VI may be stored on disk on the user's development machine at a location, e.g., c:\myapplication.vi. The VI may be opened at the same time on multiple targets. For example, the user may open the VI on the desktop target and the remote PXI RT controller. Two VI instances may be created in memory. One of the instances may be managed by the target manager instance for the desktop machine and the other by the target manger instance for the remote PXI RT controller. Each of the VI instances may exhibit behaviors specific to the target type of the particular target manager instance managing them. If a user makes an edit to a specific VI instance in memory for one target the changes may be reflected on the specific VI instance in memory for the other target. This reflection may be performed automatically or after an explicit user action invoking an update for all or a sub-set of VI instances in memory with edits made to a specific VI instance. The user may edit and run each VI instance in memory on each target independently; including viewing and debugging the front panel and block diagram of each VI instance in memory.

FIG. 7 illustrates display, e.g., for editing and/or debugging, of multiple instances of a graphical program, e.g., a VI, where the graphical program may be stored in non-volatile memory, e.g., on a hard disk. As FIG. 7 shows, in this embodiment, the user has opened a graphical program instance, in this case a block diagram and corresponding front panel for a host (e.g., desktop machine) target, and for a PXI target (e.g., an RT device target). Note that the user has opened the respective instances from different sources shown in the resource browse tree at the left side of the figure. More specifically, as indicated by arrows labeled “Opened from Here”, the localhost VI is opened from the host computer system's source tree, while the PXI (RT device) VI is opened from the hardware resource tree, under the PXI branch. Note that the block diagram of each instance has the same appearance, where, as noted above, any changes or edits made to the block diagram of one instance is preferably reflected in the other instance(s).

Creating the Graphical Program

The following describes one embodiment of a method for creating a graphical program operable to receive and respond to user interface events. It is noted that method elements in the following flowcharts may occur concurrently or in different orders than that shown.

A graphical user interface or front panel for the graphical program may be created, e.g., in response to user input. The graphical user interface may be created in any of various ways, e.g., depending on the graphical programming development environment used. A block diagram for the graphical program may be created. The block diagram may be created in or using any graphical programming development environment, such as LabVIEW, Simulink, VEE, or another graphical programming development environment. The block diagram may be created in response to direct user input, e.g., the user may create the block diagram by placing or “dragging and dropping” icons or nodes on the display and interconnecting the nodes in a desired fashion. Alternatively, the block diagram may be programmatically created from a program specification. The plurality of nodes in the block diagram may be interconnected to visually indicate functionality of the graphical program. The block diagram may have one or more of data flow, control flow, and/or execution flow representations.

It is noted that the graphical user interface and the block diagram may be created separately or together, in various orders, or in an interleaved manner. In one embodiment, the user interface elements in the graphical user interface or front panel may be specified or created, and terminals corresponding to the user interface elements may appear in the block diagram in response. For example, when the user places user interface elements in the graphical user interface or front panel, corresponding terminals may appear in the block diagram as nodes that may be connected to other nodes in the block diagram, e.g., to provide input to and/or display output from other nodes in the block diagram. In another embodiment, the user interface elements may be created in response to the block diagram. For example, the user may create the block diagram, wherein the block diagram includes terminal icons or nodes that indicate respective user interface elements. The graphical user interface or front panel may then be automatically (or manually) created based on the terminal icons or nodes in the block diagram. As another example, the graphical user interface elements may be comprised in the diagram.

Thus, various embodiments of the systems and methods described herein may facilitate multiplatform development and deployment of graphical programs.

Although the embodiments above have been described in considerable detail, numerous variations and modifications will become apparent to those skilled in the art once the above disclosure is fully appreciated. It is intended that the following claims be interpreted to embrace all such variations and modifications.

We claim:

1. A memory medium comprising program instructions for creating and executing a graphical program, wherein the program instructions are executable to implement:
storing a graphical program, wherein the graphical program comprises a plurality of interconnected nodes which visually indicate functionality of the graphical program;
storing a plurality of host target manager programs, wherein each of the host target manager programs corresponds to a possible execution target of the graphical program;
executing two or more of the host target manager programs to programmatically generate a respective two or more instances of the graphical program corresponding to respective execution targets, wherein each instance is executable by a respective device target manager program on the respective execution target;
displaying each of the two or more instances on a display device via the host target manager programs; and
deploying the two or more instances on the respective execution targets.

2. The memory medium of claim 1, wherein each of the respective host target manager programs comprises an editor component, wherein the program instructions are further executable to implement:
for at least one of the two or more instances, executing the editor component of the corresponding host target manager program to edit the instance of the graphical program.

3. The memory medium of claim 2, wherein the program instructions are further executable to implement:
updating others of the two or more instances to include modifications made in editing the at least one of the two or more instances.

4. The memory medium of claim 1, wherein at least one of the respective host target manager programs comprises a compiler component, wherein the program instructions are further executable to implement:
executing the compiler component of the at least one host target manager program to compile the corresponding instance of the graphical program.

5. The memory medium of claim 1, wherein each of the respective device target manager programs comprises an execution component, wherein the program instructions are further executable to implement:
executing the respective two or more host target manager programs to execute the execution components of the respective device target manager programs to respectively execute the two or more instances of the graphical program on the respective execution targets.

6. The memory medium of claim 1, wherein said programmatically generating the respective two or more instances of the graphical program comprises:
for at least one of the two or more instances, programmatically replacing one or more generic portions of the graphical program with one or more portions specific to the execution target.

7. The memory medium of claim 1, wherein said programmatically generating the two or more instances of the graphical program comprises:
for each of the two or more instances of the graphical program, programmatically validating the instance of the graphical program.

8. The memory medium of claim 7, wherein said programmatically validating the instance of the graphical program comprises:
programmatically analyzing the instance to determine if there are any invalid portions of the instance.

9. The memory medium of claim 8, wherein said programmatically validating the instance of the graphical program further comprises:
if there are any invalid portions of the instance of the graphical program, graphically indicating the invalid portions.

10. The memory medium of claim 8, wherein said programmatically validating the instance of the graphical program further comprises:
if there are any invalid portions of the instance of the graphical program, programmatically modifying the instance of the graphical program to correct the invalid portions.

11. The memory medium of claim 8, wherein said programmatically validating the instance of the graphical program further comprises:
if there are any invalid portions of the instance of the graphical program, modifying the instance of the graphical program to correct the invalid portions based on received user input.

12. The memory medium of claim 11, wherein said modifying the instance of the graphical program comprises programmatically performing said modifying on others of the two or more instances of the graphical program.

13. The memory medium of claim 12, wherein the program instructions are further executable to implement:
performing said modifying and said programmatically validating in an iterative manner until there are no invalid portions in the two or more instances.

14. The memory medium of claim 8, wherein said programmatically validating the instance of the graphical program further comprises:
if there are any invalid portions of the instance of the graphical program, then 1) graphically indicating the invalid portions on a display; and 2) displaying information indicating how the invalid portions can be modified or replaced to enable execution of the instance on the first execution target.

15. The memory medium of claim 8, wherein the invalid portions of the instance of the graphical program comprise portions that are not executable on the respective execution target.

16. The memory medium of claim 1, wherein said programmatically generating the two or more instances of the graphical program comprises:
programmatically removing any invalid portions.

17. The memory medium of claim 1,
wherein the graphical program is stored on a non-volatile memory;
wherein said programmatically generating the two or more instances of the graphical program comprises storing the two or more instances of the graphical program in a volatile memory.

18. The memory medium of claim 1, wherein the program instructions are further executable to implement:
receiving user input specifying the two or more execution targets, wherein said deploying the two or more instances on the respective execution targets is performed in response to said receiving user input.

19. The memory medium of claim 18,
wherein said receiving user input comprises:
displaying an icon on the display which represents the graphical program;
displaying two or more icons on the display which respectively represent the two or more execution targets; and
receiving the user input graphically associating the icon which represents the graphical program with each of the two or more icons which respectively represent the two or more execution targets;
wherein said deploying is performed in response to said graphically associating.

20. The memory medium of claim 1, wherein at least one of the device target manager programs comprises a compiler component, wherein the program instructions are further executable to implement:
executing the compiler component of the at least one device target manager program to compile the corresponding instance of the graphical program.

21. The memory medium of claim 1, wherein at least one of the respective device target manager programs comprises an execution component that is operable to implement:
executing the corresponding instance of the graphical program on the respective execution target independent from the corresponding host target manager program.

22. The memory medium of claim 1,
wherein the graphical program comprises a block diagram portion and a user interface portion; and
wherein, during execution of the corresponding instance of the graphical program, the graphical user interface is displayed on a display of a first computer system and the block diagram executes on the respective execution target.

23. The memory medium of claim 1, wherein the respective execution targets comprise one or more of:
a standalone hardware device;
an expansion card; and
a device emulator stored in the memory medium.

24. The memory medium of claim 1, wherein at least one of the respective execution targets comprises a processor and memory, and wherein after said deploying, the corresponding instance of the graphical program is executable by the processor from the memory.

25. The memory medium of claim 1, wherein at least one of the respective execution targets comprises a programmable hardware element, and wherein after said deploying, the corresponding instance of the graphical program is executable by the programmable hardware element.

26. The memory medium of claim 1, wherein the program instructions are further executable to perform:
creating the graphical program in response to user input.

27. The memory medium of claim 26, wherein said creating the graphical program comprises:
arranging a plurality of nodes on a display; and
interconnecting the plurality of nodes in response to user input.

28. The memory medium of claim 1,
wherein the graphical program comprises a graphical data flow program.

29. The memory medium of claim 1,
wherein the graphical program is operable to perform one or more of:
an industrial automation function;
a process control function;
a test and measurement function.

30. A computer-implemented method for creating and executing a graphical program, comprising:
storing a graphical program on a host computer system, wherein the graphical program comprises a plurality of interconnected nodes which visually indicate functionality of the graphical program;
storing a plurality of host target manager programs on the host computer system, wherein each of the host target manager programs corresponds to a possible execution target of the graphical program;
executing two or more of the host target manager programs to programmatically generate a respective two or more instances of the graphical program corresponding to respective execution targets, wherein each instance is executable by a respective device target manager program on the respective execution target;
displaying each of the two or more instances on a display device via the host target manager programs; and
deploying the two or more instances on the respective execution targets.

31. A system for creating and executing a graphical program, comprising:
a computer system, comprising:
a processor; and
a memory medium coupled to the processor; and
one or more execution targets coupled to the processor and memory medium, wherein each execution target comprises a respective device target manager program; and
a display device, coupled to the processor and memory medium;
wherein the memory medium stores a plurality of host target manager programs, wherein each of the host target manager programs corresponds to a possible execution target of a graphical program, and wherein each of the host target manager programs is executable to:
programmatically generate a respective instance of the graphical program corresponding to a respective execution target of the one or more execution targets; and
display the respective instance on the display device; and
wherein each instance is operable to be deployed on the respective execution target, and is executable by the respective device target manager program on the respective execution target.

32. A memory medium that stores:
a plurality of host target manager programs, wherein each of the host target manager programs corresponds to a possible execution target of a graphical program, and wherein each of the host target manager programs is executable to programmatically generate a respective instance of the graphical program corresponding to a respective execution target, and wherein each of the host target manager programs is operable to display the respective instance on a display device;
wherein each instance is operable to be deployed on the respective execution target, and is executable by a respective device target manager program on the respective execution target.

33. A system for creating and executing a graphical program, comprising:
means for storing a graphical program, wherein the graphical program comprises a plurality of interconnected nodes which visually indicate functionality of the graphical program;
means for storing a plurality of host target manager programs, wherein each of the host target manager programs corresponds to a possible execution target of the graphical program;
means for executing two or more of the host target manager programs to programmatically generate a respective two or more instances of the graphical program corresponding to respective execution targets, wherein each instance is executable by a respective device target manager program on the respective execution target;
means for displaying each of the two or more instances on a display device via the host target manager programs; and
means for deploying the two or more instances on the respective execution targets.
